(19) United States
(12) Patent Application Publication
(10) Pub. No.: US 2014/0242718 A1
(43) Pub. Date: Aug. 28, 2014

(54) PRETREATMENT DEVICE AND METHOD FOR BIOCHEMICAL REACTION

(71) Applicant: ACTHERM INC, Hsinchu City (TW)

(72) Inventor: Ying-Ho HWANG, Hsinchu City (TW)

(21) Appl. No.: 13/948,637

(22) Filed: Jul. 23, 2013

(30) Foreign Application Priority Data
Feb. 22, 2013 (TW) 102106335

(51) Int. Cl. G01N 1/40

(52) U.S. Cl. CPC G01N 1/405
USPC 436/178; 422/527

(57) ABSTRACT

A pretreatment device applied in sampling and providing a reaction space for biochemical reaction is disclosed. The pretreatment device includes a quantitative sampler being capable of collecting a constant volume of a sample; a devastating device having a hollow cylindrical structure coupled to the quantitative sampler to damage a thin-film like protective membrane of the quantitative sampler such that the reaction reagent flows out of the reagent container; a reaction device having a tubular structure and providing the reaction space for biochemical reaction of the reaction reagent and the sample; a hollow ring-shaped structure to position and stable the connection of the devastating device and the quantitative sampler with the hollow ring-shaped structure being coupled to the reaction device; and an anti-drain device preventing the reaction reagent and the sampler from flowing out before the biochemical reaction is completed.

### BACKGROUND OF THE INVENTION

1. Field of the Invention

The present invention is related to a pretreatment for biochemical reaction and more particularly related to a pretreatment device for a quantitative biochemical reaction.

2. Description of the Prior Art

In Vitro Diagnostic, referred to IVD, is a product and service to take a tissue sample such as blood, body fluids, tissue of organs from the body and for the information of clinical diagnosis. About 80% of the clinical diagnostic information derived from the in vitro diagnostic methods. Since the qualitative or quantitative detection of the IDV method, it provides various biological data from the tissue samples and help to provide the information of the diagnosis or treatment of disease. The IVD methods for human disease prevention, judgment, and tracking have become quite important now.

In process of the IVD method it is usually using a variety of diagnostic apparatus or measuring instruments with experimental techniques. The sample taken from the body has to proceed in a series of biochemical reactions before they can be analyzed, and this process is known as pretreatment. The sample and the reagent are obtained and mixed in a sampler and occurred one or more than one reactions, in this process quantitation is an important step. If the quantitation step is not precise, the IVD result may be error and the clinical judgment may be wrong, moreover the treatment for disease may be delay.

In the present pretreat equipment; the quantitative sampling method is to depend on the capillarity effect from a capillary tube or sponge, for absorbing a certain volume of the sample, such as the following patents, US. Public number US2003/0064526A1 and US2010/0055668A1 or US Issue number US66605027B2. However, when the sample is released to react with the reagent, some of the samples are left in the capillary tube or sponge. In addition, after the reacting is over, the releasing volume of the product cannot be controlled. As discuss above, there are some problems should be solved in the present pretreat equipment.

Therefore, the quantitative sample, the remainder in the sampling tube and the control of the volume of the quantitative sample are the problems required to be solved by the person with ordinary skill in the art.

### SUMMARY OF THE INVENTION

Accordingly, one object of the present invention is to provide a pretreatment device applied in sampling and providing a reaction space for biochemical reaction with a quantitative sampling function.

Another object of the present invention is to provide a pretreatment device applied in sampling and providing a reaction space for biochemical reaction to solve the problem that the sample is often remained in the sampling tube and caused the quantitative process to be not precise enough.

The other object of the present invention is to provide a pretreatment device applied in sampling and providing a reaction space for biochemical reaction to control the reacted volume of the sample so as to provide a quantitative reacted sample for detection.

According to the objects above, the present invention provides a pretreatment device applied in sampling and providing a reaction space for biochemical reaction which configured to sample and provide a reaction space for biochemical reaction occurred and the pretreatment device comprising: a quantitative sampler being an assembly structure capable of collecting a constant volume of a sample and including: a capillary tube having a hollow cylindrical structure to absorb the sample in the constant volume and including an upper end, a lower end, an internal diameter and a length, the internal diameter and the length determining the constant volume of the sample absorbed by the capillary tube, the lower end being in contact with the sample when the capillary tube absorbs the sample; a concave funnel guiding a flow of a reaction reagent, being filled with the reaction reagent; a reagent container having a cylinder structure to store the reaction reagent, including a bottom and a second outlet, and being reversely fixed on top of the concave funnel such that the second outlet faces the first inlet of the concave funnel; a thin-film like protective membrane adhered to the second outlet to seal the reagent container; a first positioning latch having a ladder-shaped structure, and being located at a side of the concave funnel; and a force-applying means disposed on top of the bottom of the reagent container to apply with a pressure to compel the reaction reagent to flow out of the reagent container; a devastating device having a hollow cylinder structure coupled to the quantitative sampler to damage the thin-film like protective membrane of the quantitative sampler to enable the reaction reagent to flow out of the reagent container, and including: a first outer wall surface having a second positioning latch being formed to protrude from the first outer wall surface and have a ladder structure and being coupled to the first positioning latch to avoid an erroneous operation of the pretreatment device; and a first inner wall surface having a first curved wall extending from the first inner wall surface toward center of the devastating device and a second curved wall extending from the first inner wall surface and along the first inner wall surface, wherein the first curved wall has a sharp end surface to damage the thin-film like protective membrane and the second curved wall guides the reaction reagent when the quantitative, sampler is connected with the devastating device; a reaction device having a tubular structure and providing the reaction space for biochemical reaction of the reaction reagent and the sample, the reaction device including: a reaction outer tube having a reaction vessel disposed inside and including a second inlet and a third outlet, the reaction vessel being capable of accommodating the capillary tube and the concave funnel such that the sample and the reaction reagent contact with each other to begin the biochemical reaction when the reaction reagent injected from the second inlet to the reaction vessel and the capillary tube and the concave funnel are flooded with the reaction reagent; a positioning protrusion having a long strip-like structure, being located in the inner wall of the reaction vessel; and

a tubular structure including a third inlet connected to the third outlet of the reaction vessel and a fourth outlet through which the reaction reagent and the sample flows out of the reaction device after the biochemical reaction is completed; a hollow ring-shaped structure to position and stable the connection of the devastating device and the quantitative sampler with the hollow ring-shaped structure being coupled to the reaction device, the hollow ring-shaped structure including: a second outer wall surface having a long strip-like shape groove located on the second outer wall surface and coupled to the positioning protrusion of the reaction device to properly activate the pretreatment device; and a second inner wall surface having a strip-like groove located on the second inner wall surface to be aligned with the first positioning latch to fix connection of the quantitative sampler and the devastating device, and a long strip-like ring-shaped concave groove located on the circumference of the inner wall surface to be connected with the strip-like groove to provide a path for the force-applying means to move along when the pressure is applied; and an anti-drain device preventing the reaction reagent and the sampler from flowing out before the biochemical reaction is completed.

The present invention also provides a pretreatment method for sampling and operating the pretreatment device comprising steps of: providing the pretreatment device; absorbing the sample in a constant volume by the capillary tube of the quantitative sampler; inserting the quantitative sampler into the reaction device, and aligning the first positioning latch of the quantitative sampler with the strip-like groove of the hollow ring-shaped structure; combining the first positioning latch with the second positioning latch of the devastating device; damaging the thin-film like protective membrane by the devastating device; allowing the reaction reagent to flow due to gravity, and flow through the sharp end surface to the concave funnel of the devastating device; flashing the sample in the capillary tube and the reaction reagent to the reaction vessel; submerging the capillary tube and the concave funnel in the reaction vessel with the reaction reagent; activating reaction of the reaction reagent and the sample in the reaction vessel for a certain time; removing the anti-drain device to allow a combination of the reacted reagent and sample flow out from the tubular structure of the reaction device; applying a pressure to the force-applying means along the long strip-like ring-shaped concave groove of the hollow ring-shaped structure to control the volume of the combination of the reacted reagent and sample; and applying a biochemical test to the combination of the reacted reagent and sample.

Therefore, the present invention provides the following advantages: 1. absorbing a quantitative sample to react with a quantitative reaction reagent; 2. scouring in accordance with immersion to solve the problem of sample residue in the sampling tube; 3. after the reaction, the releasing volume of the sample can be controlled so as to achieve the purpose of the quantitative detection.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a transparent view illustrating a pretreatment device applied in sampling and providing a reaction space for biochemical reaction according to one embodiment of the present invention;

FIG. 2 is a decomposition view illustrating the pretreatment device applied in sampling and providing a reaction space for biochemical reaction according to one embodiment of the present invention;

FIG. 3A is a structural view illustrating a quantitative sampler device of the pretreatment device according to one embodiment of the present invention;

FIG. 3B is a structural view illustrating a devastating device of the pretreatment device according to one embodiment of the present invention;

FIG. 3C is a structural view illustrating a reaction device of the pretreatment device according to one embodiment of the present invention;

FIG. 3D is a structural view illustrating a hollow ring-shaped structure of the pretreatment device according to one embodiment of the present invention;

FIG. 3E is a structural view illustrating an anti-drain device of the pretreatment device according to one embodiment of the present invention; and

FIG. 4 is a flow chart illustrating a pretreatment method for sampling and providing a reaction space for biochemical reaction according to one embodiment of the present invention.

### DESCRIPTION OF THE PREFERRED EMBODIMENT

The detailed description of the present invention will be discussed in the following embodiments, which are not intended to limit the scope of the present invention, but can be adapted for other applications. While drawings are illustrated in details, it is appreciated that the quantity of the disclosed components may be greater or less than that disclosed, except expressly restricting the amount of the components.

A pretreatment device applied in sampling and providing a reaction space for biochemical reaction is disclosed. The pretreatment device includes a quantitative sampler being an assembly structure capable of collecting a constant volume of a sample; a devastating device having a hollow cylindrical structure coupled to the quantitative sampler to damage the thin-film like protective membrane of the quantitative sampler to enable the reaction reagent to flow out of the reagent container; a reaction device having a tubular structure and providing the reaction space for biochemical reaction of the reaction reagent and the sample; a hollow ring-shaped structure to position and stable the connection of the devastating device and the quantitative sampler with the hollow ring-shaped structure being coupled to the reaction device; and an anti-drain device preventing the reaction reagent and the sampler from flowing out before the biochemical reaction is completed. The present invention includes several advantages such as absorbing a quantitative sample, quantifying a reaction reagent and solving the problem of the sample residue in the sampling tube. Therefore, the present invention can provide a precise volume of the reacted sample for biochemical testing.

The following definitions are to clarify the meaning of the terms using in the description.

The term “sample” is that a liquid sample absorbed by capillarity effect and is used to contact with a quantitative reagent for occurring a biological or chemical reaction. The liquid sample is such as a biological fluid, blood, urine, saliva, antigens, proteins, RNA, DNA.

The term “the pretreatment device” represents that the original sample should be in a biological or chemical treatment before a biochemical testing, for example, dilution or reaction with a particular reagent. Then the follow-up product can be used in the biochemical testing. The device providing this biological or chemical treatment occurred is referred to as the pretreatment device.

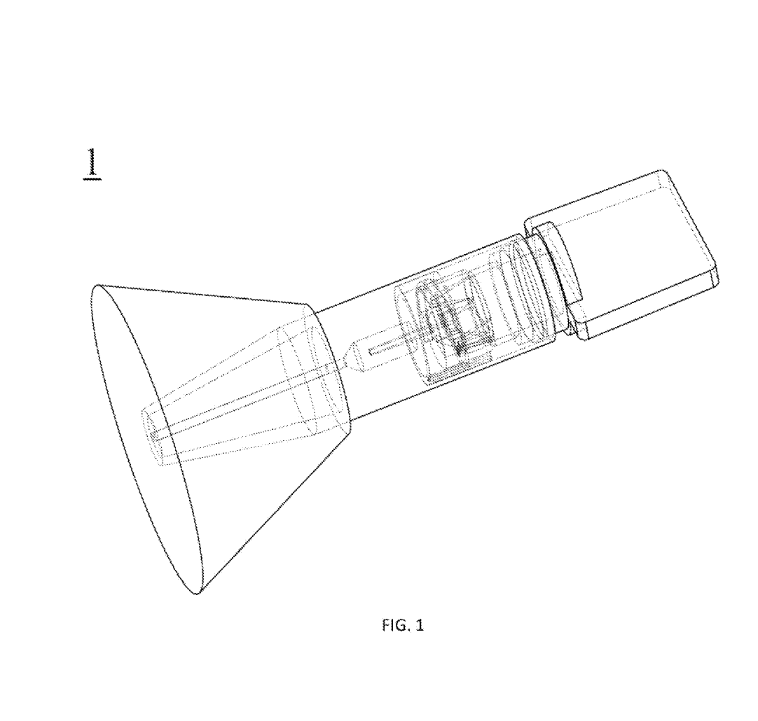

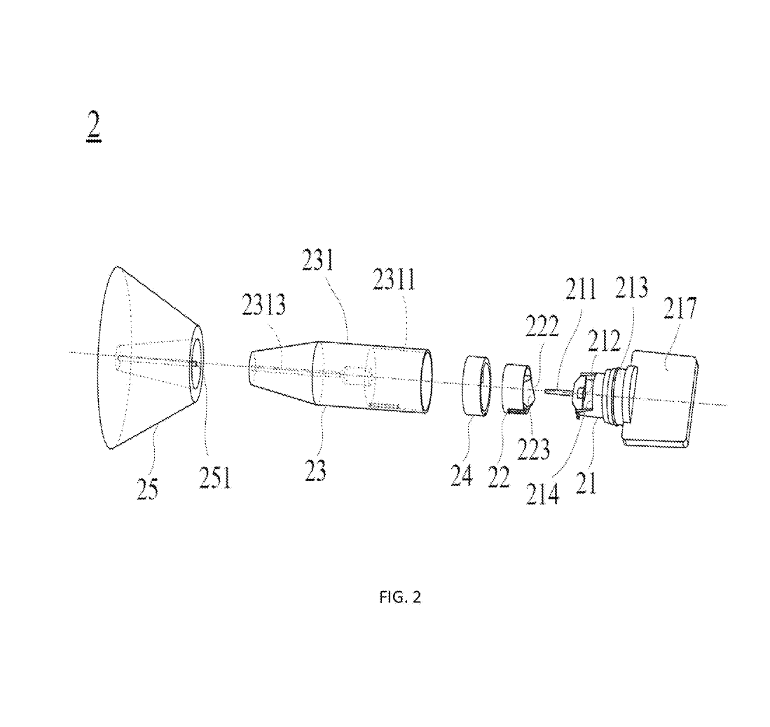

Please refer to FIG. 1-2, FIG. 1 is a transparent view illustrating a pretreatment device applied in sampling and providing a reaction space for biochemical reaction in the present invention and FIG. 2 is a decomposition view thereof. The components thereof are a quantitative sampler 21, a devastating device 22, a reaction device 23, a hollow ring-shaped structure 24 and an anti-drain device 25. As shown in the transparent view, when the combination of the various parts, the capillary tube 211 of the quantitative sampler 21 and the concave funnel 212 is accommodated to the reaction vessel 2311 of the reaction device 23. In addition, when the combination of the various parts, the sharp end surface 222 on the first curved wall will destroy the thin-film like protective membrane 214 and a reaction reagent in the reagent container 213 is flowing out due to gravity. The reaction reagent is guided through the sharp end surface 222 to the second curved wall 233, which acting as the guiding pillar, and then the reagent is flowing into the concave funnel 212 on top of the capillary tube 211. The reagent in the concave funnel 212 immediately scours the sample within the capillary tube 211 out of the capillary tube to the reaction vessel 2311. After the reaction reagent completely flows out of the reagent container 213, the capillary tube 211 and the concave funnel 212 will submerge by the reaction reagent and the sample left in the capillary tube 211 can be completely reacted with the reaction reagent.

Accordingly, when the reaction vessel 2311 is filled with the reaction reagent, the sample on the capillary tube 211 is immersed and flushed for solving the problem of the sample residue in the sampling tube. In addition, the pillar structure 251 of the anti-drain device 25 blocks the tubular structure 2313 when reacting to prevent the reaction reagent and the sample flowing out before biochemical reaction is completed. After the reaction is completed, the anti-drain device is horizontally removed. The volume scale (not shown) is marked on the reaction outer tube 231 to control the flowing volume of the liquid, or thought sound and vibration to know the flowing volume of the liquid by rotation. The principium is that since the devastating device 22 and the quantitative sampler 21 are mutually latched, they are rotate together within the spiral long strip-like ring-shaped concave groove (not shown) of the hollow ring-shaped structure 24 and the positioning sound and vibration generated by a noise sheet of the quantitative sampler 21 and the hollow ring-shaped structure 24, so users were informed the amount of the liquid volume by sound and vibration. According to the method above, the effect of the quantitative detection achieved. After determining the spinning amount of liquid volume, it can use with a detecting reactant to test and the detecting reactant can be reactive specimen, biochemical machine, optical machine and so on. Finally put the pillar structure 251 back in the tubular structure 2313, and then the device can be discarded.

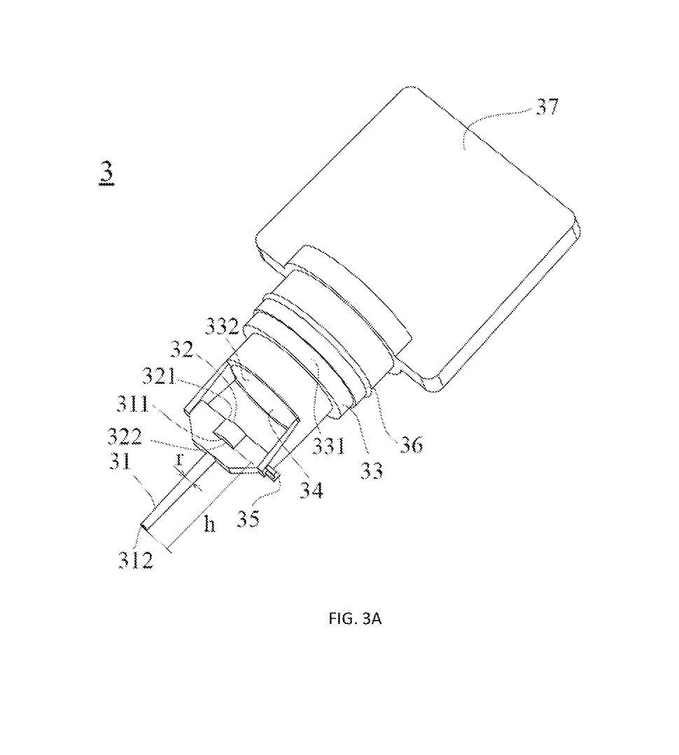

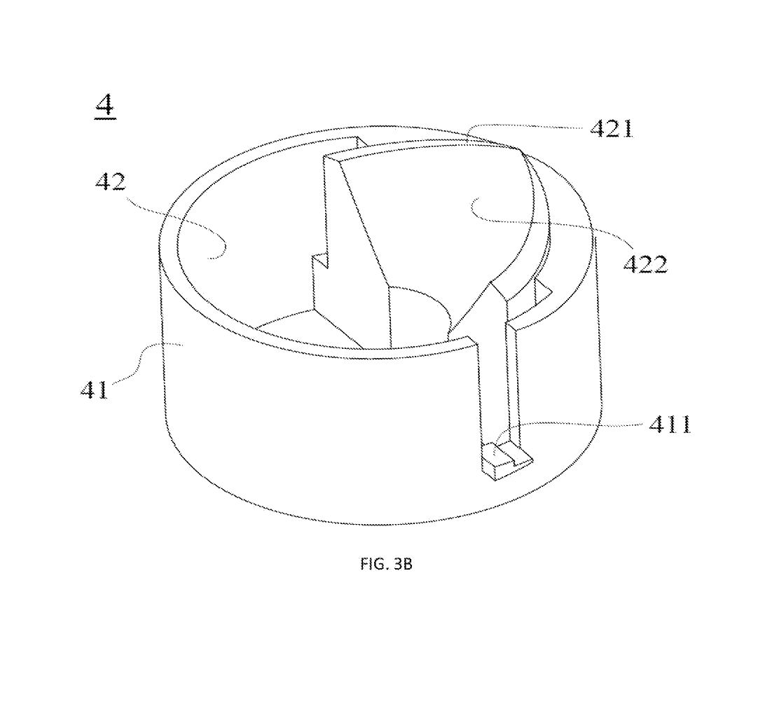

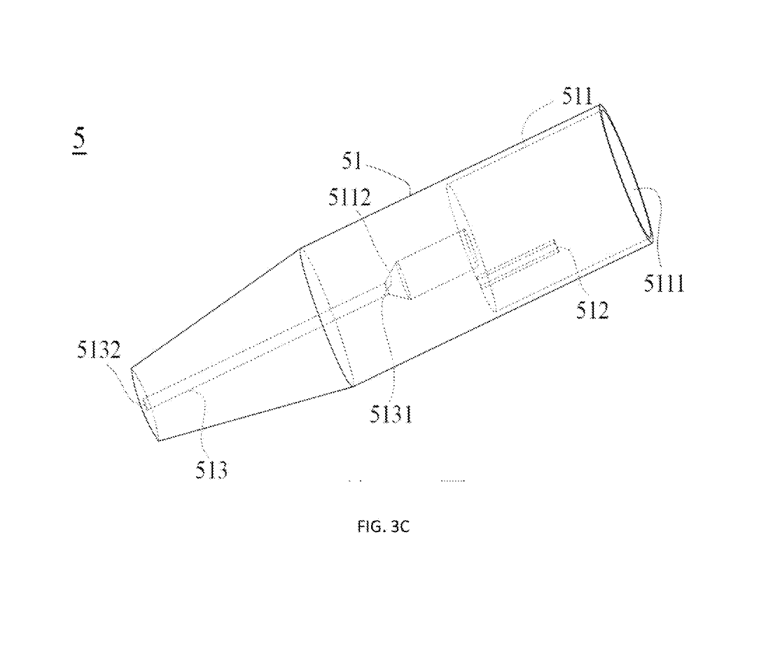

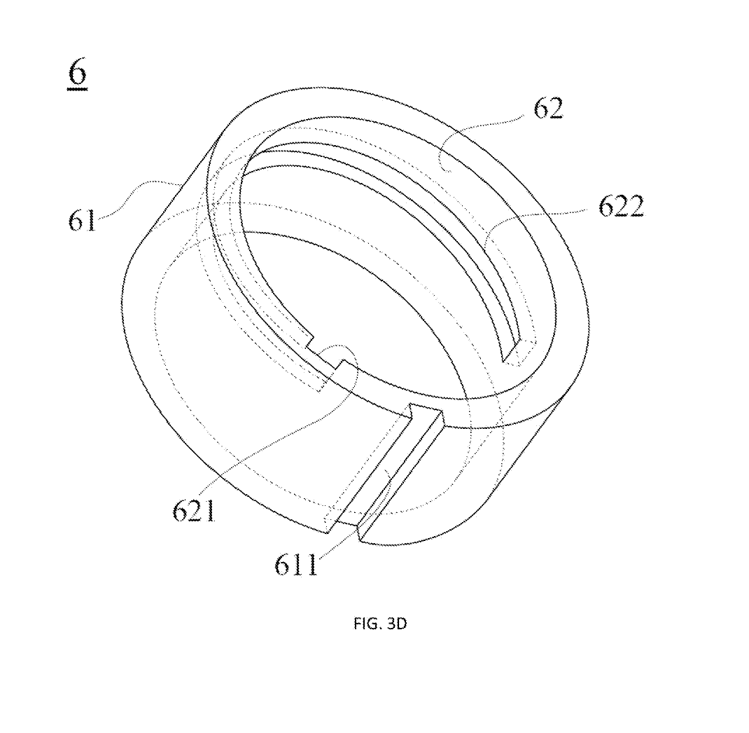

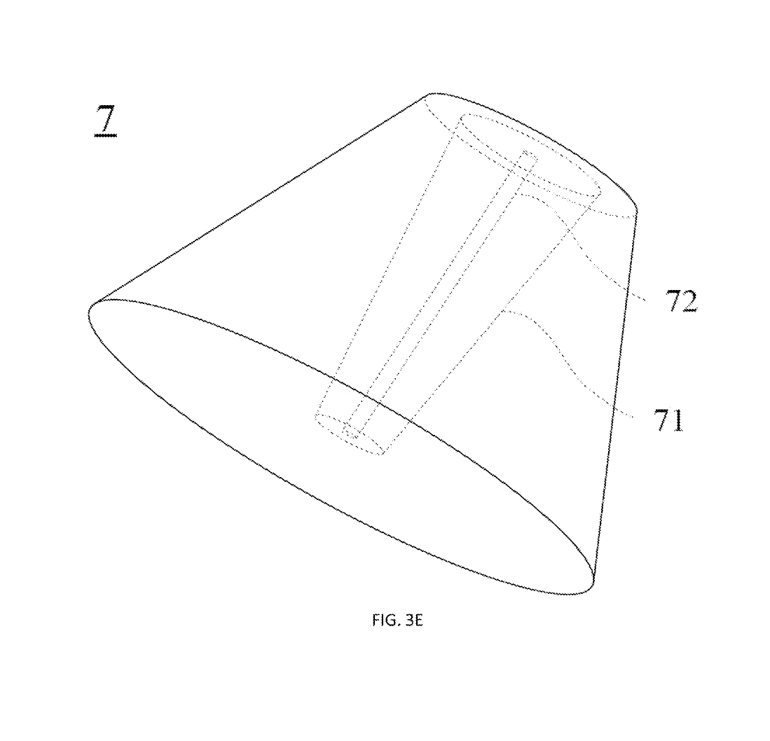

Please still refer to FIG. 3A to FIG. 3E, which are structural views and transparent view illustrating each of the components of the pretreatment device applied in sampling and providing a reaction space for biochemical reaction in the embodiment of the present invention. The features and combining method of the components in pretreatment device is following described in detail. Please refer to FIG. 3A, it is the quantitative sampler 3 of the pretreatment device 1 and 2 in the present embodiment. The quantitative sampler 3 is an assembly structure capable of collecting a constant volume of a sample. The quantitative sampler 3 includes: a capillary tube 31, a concave funnel 32, a reagent container 33, a thin-film like protective membrane 34, a first positioning latch 35, a force-applying means 37, and an airtight ring 36.

The capillary tube 31 having a hollow cylindrical structure is used to absorb a sample in the constant volume. The capillary tube 31 includes: an upper end 311, a lower end 312, an inner diameter r, and a length h. The lower end 312 is in contact with the sample for absorbing the sample by capillary effect and the capillary tube 31 will be filled with the liquid sample. The inner diameter r and length h determines the absorbed sample volume of the capillary tube 31 by capillary effect, since inner diameter r multiplied the length h equal the absorbed sample volume of the capillary tube 31, the purpose for absorbing the constant volume of the sample can be reached.

A concave funnel 32 with a funnel shaped structure is used for guiding a flow of a reaction reagent, being filled with the reaction reagent. The concave funnel 32 includes: a first inlet 321 and a first outlet 322. The first inlet 321 is for the reaction reagent flowing into the concave funnel 32 and a first outlet 322 is connected with the upper end 311 of the capillary tube 31, the reagents will flow through the first inlet 321, the first outlet 322 and be reacted with the sample within the capillary tube 31 for a biochemical reaction.

The reagent container 33 having a cylinder shape structure is used for storing the reaction reagent. The reagent container 33 includes a bottom 331 and a second outlet 332 and is reversed and fixed on top of the concave funnel 32, so that the second outlet 332 is facing to the first inlet 321 of the concave funnel 32.

The thin-film like protective membrane 34 is adhered to the second outlet 332, so that the reaction reagent is sealed in the reagent container 33.

The first positioning latch 15 having a ladder-shaped structure being located at a side of the concave funnel 32 and configured to avoid the error operation of the pretreatment device 1 and 2 before biochemical reaction.

The force-applying means 37 is disposed on top of the bottom 331 of the reagent container 33 and is configured to be applied with a pressure to compel the reaction reagent to flow out of the reagent container 33. The pressure can be provided by rotating and pressing. In the present embodiment, the rotating method is used. The shape of the force-applying means 37 in the present embodiment can be a sheet shape structure of and can also be a pillar shape structure and a rod structure.

The airtight ring 36 with an annular structure is an elastic material, such as polymers, polymers, plastics, fibers, etc. and covers on the reagent container 33. When the quantitative samplers 21 and 31, the sharp end surface 22, the reaction device 23 and the hollow ring-shaped structure 24 are combined together to provide air tightness for the reagent container 33 and the reaction reagent able to successfully flow out of the reagent container 33.

Please refer to FIG. 3B, which is view illustrating the devastating device of the pretreatment devices 1 and 2 in one embodiment of the present invention. The devastating device 4 is coupled to the quantitative sampler 3 to damage the thin-film like protective membrane 34 for the reaction reagent flowing out of the reagent container 33. The devastating device 4 having a hollow cylinder structure includes a first outer wall surface 41 and a first inner wall surface 42. The first outer wall surface 41 having a second positioning latch 411 with the second positioning latch protruding from the first outer wall surface 41 and having a ladder structure. The first outer wall surface 41 is coupled to the first positioning latch 15 to avoid an erroneous operation of the pretreatment device 1 and 2. The first inner wall surface 42 having a first curved wall extending from the first inner wall surface toward center of the devastating device and a second curved wall extending from the first inner wall surface and along the first inner wall surface, wherein the first curved wall has a sharp end surface 421 including a tapering portion to damage the thin-film like protective membrane 214 and a second curved wall 422. The second curved wall 422 is connected to the sharp end surface 421 and guiding the reaction reagent when the quantitative sampler 3 is connected with the devastating device 4 In addition, the shape of the sharp end surface 421 can also be a needle shape instead of a pointing shape in the present embodiment.

Please refer to FIG. 3C, which is a view illustrating the reaction device 5 of the pretreatment devices 1 and 2 in one embodiment of the present invention. The reaction device 5 is having a tubular structure and providing the reaction space for biochemical reaction of the reaction reagent. The reaction device 5 includes a reaction outer tube 51 having a reaction vessel 511 disposed inside, which including a second inlet 5111 and a third outlet 5112. The reaction vessel 511 is capable of accommodate the capillary tube 31 and the concave funnel 32. The reaction reagent is injected into the reaction vessel 511 from the second inlet 5111 and the capillary tube 31 and the concave funnel 32 is submerged by the reaction reagent, so that the reagent is contacted with the sample in the capillary tube 31 to begin a biochemical reaction. A positioning protrusion 512 with a long strip-like structure is located in the inner wall of the reaction vessel 511 and configured to combine with a long strip-like shape groove 611 for proper starting the pretreatment device 1 and 2. The tubular structure 513 includes a third inlet 5131 and a fourth outlet 5132. The third inlet 5131 is connected to the third outlet 5112 of the reaction vessel 511, and the fourth outlet 5132 is for the reaction reagent and the sample flowing out after the biochemical reaction is completed. In addition, the reaction outer tube 51 has the volume scale, using to mark the volume of the outflow liquid. The reaction vessel 511 is a tubular shape and can also be a cup shape and polygon columnar shape and so on.

Please refer to FIG. 3D, which is a view illustrating the hollow ring-shaped structure 6 of the pretreatment device 1 and 2 in one embodiment of the present invention. The hollow ring-shaped structure 6 is to position and stable the connection of the devastating device 4 and the quantitative sampler 3 with the hollow ring-shaped structure being coupled to the reaction device 5 and includes a second outer wall surface 61 and a second inner wall surface 62. The second outer wall surface 61 has a long strip-like shape groove 611 which is located on the second outer wall surface 61. The long strip-like shape groove 611 is a long strip concave structure coupling to the positioning protrusion 521 of the reaction device 5. The second inner wall surface 62 includes a strip-like groove 621 with a long strip-like ring-shaped concave groove 622. The strip-like groove 621 is located on the second inner wall surface 62 to be aligned with the first positioning latch to fix connection of the quantitative sampler 3 and the devastating device 4. A long strip-like ring-shaped concave groove 622 located on the circumference of the second inner wall surface 62 to be connected with the strip-like groove 621. The long strip-like ring-shaped concave groove 622 is to provide a path for the force-applying means 37 for applying a pressure to move along when the pressure is applied. The long strip-like ring-shaped concave groove 622 can be a spiral or linear shape. In the present embodiment, the long strip-like ring-shaped concave groove 622 is a spiral shape.

Please refer to FIG. 3E, which is a view illustrating the anti-drain device 7 of the pretreatment devices for biochemical reaction 1 and 2 in one embodiment of the present invention. The anti-drain device 7 is used to prevent the reactive reagent and the sample flowing out from the tubular structure 513 before the biochemical reaction is completed. The anti-drain device 7 includes a fixing groove 71 with a concave structure to accommodate the reaction device 5 and providing a space for the reaction device 5. A pillar structure 72 is connected with the tubular structure 513 to prevent the reaction reagent and the sample flowing out from the tubular structure 513 before the biochemical reaction is completed.

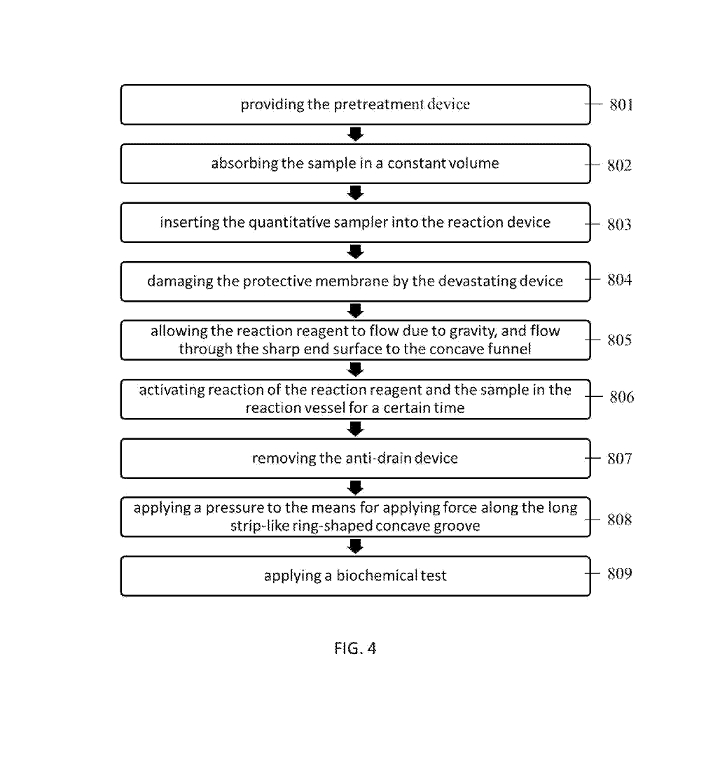

In addition, the present invention also provides a pretreatment method for sampling and operating the pretreatment device 1 and 2. Please refer to FIG. 4, step 801 to step 809. In step 801, it is to provide a the pretreatment devices 1 and 2

In step 802, it is to sample by the capillary tube 211, 31 of the quantitative sampler 21, 3 to absorb the sample in a constant volume by capillary.

In step 803, it is to insert the quantitative sampler 21, 3 into the reaction device 23, 5, and align the first positioning the latch 35 of the quantitative sampler 21, 3 with the strip-like groove 621 of the hollow ring-shaped structure 24,6. After inserting to the bottom of the lowest position, the first positioning latch 35 is combined with the second positioning latch 411 of the devastating device 22, 4. After these steps, the pretreatment devices 1 and 21 for biochemical reaction are properly started.

In step 804, it is to damage the thin-film like protective membrane 214, 34 by the sharp end surface 222, 421.

In step 805, it is to allow the reaction reagent to flow out due to gravity, and flow through the sharp end surface 222, 421 to the concave funnel 212, 32 of the devastating device 22, 4. The sample in the capillary tube 211, 31 and the reaction reagent are flashed to the reaction vessel 2311, 511. After the reaction reagent is fully flowing out, the capillary tube 211, 31 and the concave funnel 212, 32 will submerge in the reaction vessel 2311, 511 with the reaction reagent.

In step 806, it is to activate reaction of the reaction reagent and the sample in the reaction vessel 2311, 511 for a certain time.

In step 807, it is to remove the anti-drain device 25, 7 and allow a combination of the reacted reagent and sample to flow out from the tubular structure 2313, 513 of the reaction device 23, 5.

In step 808, it is to apply a pressure to the force-applying means 217, 37 along the long strip-like ring-shaped concave groove 622 of the hollow ring-shaped structure 24, 6 to control the volume of the combination of the reacted reagent and sample. The pressure can be a rotating or pressing pressure. In the present embodiment, the rotating pressure is used to release the volume of the combination of the reacted reagent and sample. And in step 809, it is to apply a biochemical test to the combination of the reacted reagent and sample.

In summary, the present invention provides the following advantages: 1. absorbing a quantitative sample to react with a quantitative reaction reagent; 2. scouring in accordance with immersion to solve the problem of sample residue in the sampling tube; 3. After the reaction, the releasing volume of the sample can be controlled so as to achieve the purpose of the quantitative detection.

Although specific embodiments have been illustrated and described, it will be appreciated by those skilled in the art that various modifications may be made without departing from the scope of the present invention, which is intended to be limited solely by the appended claims.

What is claimed is:

1. A pretreatment device applied in sampling and providing a reaction space for biochemical reaction, comprising:
a quantitative sampler being an assembly structure capable of collecting a constant volume of a sample and including:
a capillary tube having a hollow cylindrical structure to absorb the sample in the constant volume and including an upper end, a lower end, an internal diameter and a length, the internal diameter and the length determining the constant volume of the sample absorbed by the capillary tube, the lower end being in contact with the sample when the capillary tube absorbs the sample;
a concave funnel guiding a flow of a reaction reagent, being filled with the reaction reagent, and including:
a first inlet through which the reaction reagent flows into the concave funnel; and
a first outlet connected with the upper end of the capillary tube, wherein the reaction reagent flows through the first inlet, the first outlet and contacts the sample within the capillary tube to begin a biochemical reaction;
a reagent container having a cylinder structure to store the reaction reagent, including a bottom and a second outlet, and being reversely fixed on top of the concave funnel such that the second outlet faces the first inlet of the concave funnel;
a thin-film like protective membrane adhered to the second outlet to seal the reagent container;
a first positioning latch having a ladder-shaped structure, and being located at a side of the concave funnel; and
a force-applying means disposed on top of the bottom of the reagent container, to which a pressure is applied to compel the reaction reagent to flow out of the reagent container;
a devastating device having a hollow cylinder structure coupled to the quantitative sampler to damage the thin-film like protective membrane of the quantitative sampler to enable the reaction reagent to flow out of the reagent container, and including:
a first outer wall surface having a second positioning latch being formed to protrude from the first outer wall surface and have a ladder structure and being coupled to the first positioning latch to avoid an erroneous operation of the pretreatment device; and
a first inner wall surface having a first curved wall extending from the first inner wall surface toward center of the devastating device and a second curved wall extending from the first inner wall surface and along the first inner wall surface, wherein the first curved wall has a sharp end surface to damage the thin-film like protective membrane and the second curved wall guides the reaction reagent when the quantitative sampler is connected with the devastating device;
a reaction device having a tubular structure and providing the reaction space for biochemical reaction of the reaction reagent and the sample, the reaction device including:
a reaction outer tube having a reaction vessel disposed inside and including a second inlet and a third outlet, the reaction vessel being capable of accommodating the capillary tube and the concave funnel such that the sample and the reaction reagent contact with each other to begin the biochemical reaction when the reaction reagent injected from the second inlet to the reaction vessel and the capillary tube and the concave funnel are flooded with the reaction reagent;
a positioning protrusion having a long strip-like structure, being located in the inner wall of the reaction vessel; and
a tubular structure including a third inlet connected to the third outlet of the reaction vessel and a fourth outlet through which the reaction reagent and the sample flows out of the reaction device after the biochemical reaction is completed;
a hollow ring-shaped structure to position and stable the connection of the devastating device and the quantitative sampler with the hollow ring-shaped structure being coupled to the reaction device, the hollow ring-shaped structure including:
a second outer wall surface having a long strip-like shape groove located on the second outer wall surface and coupled to the positioning protrusion of the reaction device to properly activate the pretreatment device; and
a second inner wall surface having a strip-like groove located on the second inner wall surface to be aligned with the first positioning latch to fix connection of the quantitative sampler and the devastating device, and a long strip-like ring-shaped concave groove located on the circumference of the inner wall surface to be connected with the strip-like groove to provide a path for the force-applying means to move along when the pressure is applied; and
an anti-drain device preventing the reaction reagent and the sampler from flowing out before the biochemical reaction is completed.

2. The pretreatment device of claim 1, wherein a shape of the force-applying means is selected from the group consisting of sheet shape, pillar shape and rod shape.

3. The pretreatment device of claim 1, wherein the quantitative sampler further includes an airtight ring to provide air tightness for the reagent container.

4. The pretreatment device of claim 1, wherein a shape of the reaction vessel is selected from the group consisting of tube shape, cup shape and polygon columnar shape.

5. The pretreatment device of claim 1, wherein the sharp end surface of the first curved wall includes a tapering portion.

6. The pretreatment device of claim 1, wherein a shape of the long strip-like ring-shaped concave groove is selected from the group consisting of spiral shape and linear shape.

7. The pretreatment device of claim 1, wherein the anti-drain device includes: a concave structure to accommodate the reaction device, and a pillar structure connected with the tubular structure to prevent the reaction reagent and the sampler from flowing out of the tubular structure before biochemical reaction is completed.

8. The pretreatment device of claim 1, wherein the reaction outer tube has a volume scale.

9. A pretreatment method for sampling and operating the pretreatment device of claim 1, comprising step of:
providing the pretreatment device;
absorbing the sample in a constant volume by the capillary tube of the quantitative sampler;
inserting the quantitative sampler into the reaction device, and aligning the first positioning latch of the quantitative sampler with the strip-like groove of the hollow ring-shaped structure; combining the first positioning latch with the second positioning latch of the devastating device;
damaging the thin-film like protective membrane by the devastating device;
allowing the reaction reagent to flow due to gravity, and flow through the sharp end surface to the concave funnel of the devastating device;
flashing the sample in the capillary tube and the reaction reagent to the reaction vessel; submerging the capillary tube and the concave funnel in the reaction vessel with the reaction reagent;
activating reaction of the reaction reagent and the sample in the reaction vessel for a certain time;
removing the anti-drain device to allow a combination of the reacted reagent and sample flow out from the tubular structure of the reaction device;
applying a pressure to the force-applying means along the long strip-like ring-shaped concave groove of the hollow ring-shaped structure to control the volume of the combination of the reacted reagent and sample; and
applying a biochemical test to the combination of the reacted reagent and sample.
